(19) United States
(12) Patent Application Publication
(10) Pub. No.: US 2022/0043553 A1
(43) Pub. Date: Feb. 10, 2022

(54) SIGNAL DRIVING METHOD, SIGNAL DRIVING APPARATUS, STYLUS AND SIGNAL DRIVING SYSTEM

(71) Applicant: SHENZHEN GOODIX TECHNOLOGY CO., LTD., Shenzhen (CN)

(72) Inventors: Qiquan LIANG, Shenzhen (CN); Xianpeng CHEN, Shenzhen (CN)

(73) Assignee: SHENZHEN GOODIX TECHNOLOGY CO., LTD., Shenzhen (CN)

(21) Appl. No.: 17/506,896

(22) Filed: Oct. 21, 2021

Related U.S. Application Data
(63) Continuation of application No. PCT/CN2019/128352, filed on Dec. 25, 2019.

(51) Int. Cl. G06F 3/041; G06F 3/0354

(52) U.S. Cl. CPC G06F 3/04162; G06F 3/03545

(57) ABSTRACT

A signal driving method is provided, configured for a stylus to send a driving signal to a touch screen, where the driving signal is configured for the touch screen to determine location information and/or pressure information of the stylus on the touch screen. The method includes: the stylus detecting an uplink signal sent by the touch screen according to a first signal driving mode; and the stylus switching from a first signal driving mode to a second signal driving mode according to a detection result of the above uplink signal.

### CROSS-REFERENCE TO RELATED APPLICATIONS

This application is a continuation of International Application No. PCT/CN2019/128352, filed on Dec. 25, 2019, the disclosure of which is hereby incorporated by reference in its entirety.

### TECHNICAL FIELD

The present application relates to the field of information technology, and in particular, to a signal driving method, a signal driving apparatus, a stylus, and a signal driving system.

### BACKGROUND

At present, as a major peripheral input fitting, a stylus is gradually receiving attention from market. A tip of the stylus can emit a driving signal. And there are a certain quantity of horizontally and vertically distributed detection electrodes on a touch screen. Therefore, a signal emitted from the tip can be detected by the detection electrode, and a two-dimensional coordinate of the tip on the touch screen can be calculated based on a detecting signal.

There are two types of styluses. One type is the stylus that periodically drives, the stylus periodically sends the driving signal, and the touch screen samples the driving signal based on a same cycle. The other type is the stylus that an uplink (UL) signal triggers the driving. Some touch screens can send the uplink signal to the stylus through the detection electrode, and then the stylus sends the driving signal to the touch screen after the uplink signal is detected. However, each type of the stylus can only be applied to one type of the touch screen, and cannot achieve the purpose of writing on multiple touch screens with one stylus, that is, “one pen for multiple devices” cannot be achieve, which greatly limits the range of use of the stylus.

### SUMMARY

Embodiments of the present application provide a signal driving method, a signal driving apparatus, a stylus, and a signal driving system, which can support the stylus to write on a plurality of touch screens.

In a first aspect, a signal driving method is provided, configured for a stylus to send a driving signal to a touch screen, where the driving signal is configured for the touch screen to determine location information and/or pressure information of the stylus on the touch screen. The method includes: the stylus detecting an uplink signal sent by the touch screen, according to a first signal driving mode; the stylus switching from a first signal driving mode to a second signal driving mode, according to a detection result of the above uplink signal; the stylus sending a driving signal to the touch screen according to the second signal driving mode, where the driving signal is configured for the touch screen to determine the position information and/or the pressure information of the stylus on the touch screen.

In a possible implementation manner, the first signal driving mode is a mode that periodically sends a driving signal, wherein each cycle includes a first period and a second period, the first period is configured to send the driving signal, and the second period is configured to detect an uplink signal; and the second signal driving mode is a mode that sends a driving signal based on an uplink signal, where the stylus sends the driving signal in response to a correctly detected uplink signal.

In a possible implementation manner, the stylus detecting an uplink signal sent by a touch screen, according to a first signal driving mode, includes: the stylus detecting a plurality kinds of uplink signals respectively in a plurality of consecutive cycles, where coding information of the plurality kinds of uplink signals is different.

In a possible implementation manner, the stylus detecting an uplink signal sent by a touch screen, according to a first signal driving mode, includes: the stylus detecting a plurality of kinds of uplink signals in each cycle, where coding information of the plurality kinds of uplink signals is different.

In a possible implementation manner, the stylus detecting an uplink signal sent by a touch screen, according to a first signal driving mode, includes: the stylus detecting a plurality sets of the uplink signals respectively in a plurality of consecutive cycles, where each set of the uplink signals includes a plurality kinds of uplink signals, and coding information of the plurality kinds of uplink signals is different.

In a possible implementation manner, the stylus switching from a first signal driving mode to a second signal driving mode, according to the detection result of the uplink signal, includes: if the number of times that the stylus correctly detects an uplink signal is greater than N, the stylus switching from the first signal driving mode to the second signal driving mode, where N is a positive integer.

In a possible implementation manner, the first signal driving mode is a mode that sends a driving signal based on an uplink signal, where a stylus sends the driving signal in response to a correctly detected uplink signal; and the second signal driving mode is a mode that periodically sends a driving signal, where each cycle includes a first period and a second period, the first period is configured to send the driving signal, and the second period is configured to detect an uplink signal.

In a possible implementation manner, the stylus switching from a first signal driving mode to a second signal driving mode, according to a detection result of the uplink signal, includes: if the number of times that the stylus does not correctly detect an uplink signal is greater than M, the stylus switching from the first signal driving mode to the second signal driving mode, where M is a positive integer.

In a possible implementation manner, the first signal driving mode is a mode that sends a driving signal based on an uplink signal, where a stylus sends the driving signal in response to an uplink signal corresponding to the first signal driving mode; and the second signal driving mode is a mode that sends a driving signal based on an uplink signal, where the stylus sends the driving signal in response to an uplink signal corresponding to the second signal driving mode, coding information of the uplink signal corresponding to the second signal driving mode is different from that of the uplink signal corresponding to the first signal driving mode.

In a possible implementation manner, the stylus switching from a first signal driving mode to a second signal driving mode, according to the detection result of the uplink signal, includes: if the number of times that the stylus does not correctly detect the uplink signal corresponding to the first signal driving mode is greater than M, the stylus switching from the first signal driving mode to the second signal driving mode, where M is a positive integer.

In a possible implementation manner, the coding information includes at least one of: a length of coded pulse, pulse sequence, code system, and bit of coded digits.

In a second aspect, a signal driving apparatus is provided, configured to send a driving signal to a touch screen, where the driving signal is configured for the touch screen to determine location information and/or pressure information of the stylus on the touch screen, and the stylus includes: a processing module, configured to detect an uplink signal sent by a touch screen according to a first signal driving mode; the processing module further configured to switch from a first signal driving mode to a second signal driving mode according to a detection result of the uplink signal; and a sending module, configured to send a driving signal to the touch screen, according to the second signal driving mode, where the driving signal is configured for the touch screen to determine the location information and/or the pressure information of the stylus on the touch screen.

In a possible implementation manner, the first signal driving mode is a mode that periodically sends a driving signal, where each cycle includes a first period and a second period, the first period is configured to send the driving signal, and the second period is configured to detect an uplink signal; and the second signal driving mode is a mode that sends a driving signal based on an uplink signal, where the stylus sends the driving signal in response to a correctly detected uplink signal.

In a possible implementation manner, the processing module is specifically configured to: detect a plurality kinds of uplink signals respectively in a plurality of consecutive cycles, where coding information of the plurality kinds of uplink signals is different.

In a possible implementation manner, the processing module is specifically configured to: detect a plurality of kinds of uplink signals in each cycle, where coding information of the plurality kinds of uplink signals is different.

In a possible implementation manner, the processing module is specifically configured to: detect a plurality sets of the uplink signals respectively in a plurality of consecutive cycles, where each set of the uplink signals includes a plurality kinds of uplink signals, and coding information of the plurality kinds of uplink signals is different.

In a possible implementation manner, the processing module is specifically configured to: switch from the first mode to the second mode, if the number of times that the stylus correctly detects an uplink signal is greater than N, where N is a positive integer.

In a possible implementation manner, the first signal driving mode is a mode that sends a driving signal based on an uplink signal, where a stylus sends the driving signal in response to a correctly detected uplink signal; and the second signal driving mode is a mode that periodically sends a driving signal, where each cycle includes a first period and a second period, the first period is configured to send the driving signal, and the second period is configured to detect an uplink signal.

In a possible implementation manner, the processing module is specifically configured to: switch from the first signal driving mode to the second signal driving mode, if the number of times that the stylus does not correctly detect an uplink signal is greater than M, where M is a positive integer.

In a possible implementation manner, the first signal driving mode is a mode that sends a driving signal based on an uplink signal, where a stylus sends the driving signal in response to an uplink signal corresponding to the first signal driving mode; and the second signal driving mode is a mode that sends a driving signal based on an uplink signal, where a stylus sends the driving signal in response to an uplink signal corresponding to the second signal driving mode, coding information of the uplink signal corresponding to the first driving signal is different from that of the uplink signal corresponding to the second signal driving mode.

In a possible implementation manner, the processing module is specifically configured to: switch from the first signal driving mode to the second signal driving mode, if the number of times of an uplink signal that is not correctly detected corresponding to the first signal driving mode is greater than M, where M is a positive integer.

In a possible implementation manner, the coding information includes at least one of: a length of coded pulse, pulse sequence, code system, and bit of coded digits.

In a third aspect, a stylus is provided, including: a touch screen; and the foregoing signal driving apparatus in the second aspect and any one of the possible implementation manners of the second aspect.

In a fourth aspect, a signal driving system is provided, including: a touch screen; and the foregoing stylus in the third aspect and any one of the possible implementation manners of the third aspect.

Based on the above technical solution, the stylus detects the uplink signal and switches between a plurality of signal driving modes according to the detection result of the uplink signal, such that the stylus can write on the touch screen that supports different signal driving modes.

### BRIEF DESCRIPTION OF DRAWINGS

FIG. 1 is a schematic diagram of periodically signal driving;

FIG. 2 is a schematic diagram of an uplink signal triggering the signal driving;

FIG. 3 is a schematic flowchart of a signal driving method according to an embodiment of the present application;

FIG. 4 is a schematic diagram of a signal driving mode according to an embodiment of the present application;

FIG. 5 is a schematic diagram of a possible implementation manner based on the method shown in FIG. 1;

FIG. 6 is a schematic diagram of a possible implementation manner based on the method shown in FIG. 5;

FIG. 7 is a schematic diagram of a possible implementation manner based on the method shown in FIG. 5;

FIG. 8 is a schematic diagram of a possible implementation manner based on the method shown in FIG. 5;

FIG. 9 is a schematic diagram of an uplink signal according to an embodiment of the present application;

FIG. 10 is a schematic diagram of an uplink signal according to an embodiment of the present application;

FIG. 11 is a schematic diagram of a possible implementation manner based on the method shown in FIG. 1; and

FIG. 12 is a schematic block diagram of a signal driving apparatus according to an embodiment of the present application.

### DESCRIPTION OF EMBODIMENTS

The following describes the technical solutions of the present application with reference to the accompanying drawings.

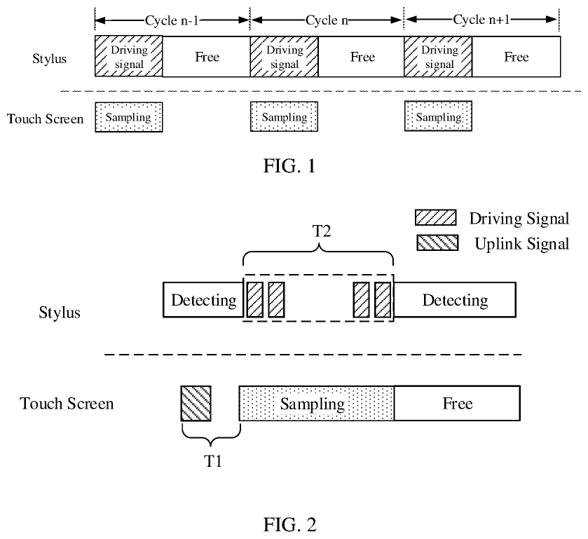

At present, there are two types of styluses. One type is the stylus that periodically drives. As shown is FIG. 1, this type of the stylus periodically sends a driving signal to an touch screen, for example, in cycle n−1, cycle n, or cycle n+1, the stylus sends a driving signal to the touch screen during the time period shown by the shadow, and is free for the rest of the cycle. The touch screen samples the driving signal based on the same period.

The other type is the stylus that an uplink signal triggers the driving. Since some touch screens can send the uplink signal to the stylus through the detection electrode, for this type of the stylus, it will only send a driving signal to the touch screen after the uplink signal is detected. As shown in FIG. 2, the touch screen sends the uplink signal, and the stylus detects the uplink signal. If the stylus correctly detects the uplink signal sent by the touch screen, and the stylus sends the driving signal to the touch screen after the time delay T1. The time delay T1 can be considered as the signal processing time of the stylus, which is configured for the stylus to process the uplink signal and prepare the driving signal. After the uplink signal is detected and the time delay T is experienced, the stylus sends the driving signal to the touch screen. The driving signal sent by the stylus can last for a certain period of time T2. Correspondingly, after the touch screen sends the uplink signal, it starts to sample the driving signal sent by the stylus after the time delay T1. After the stylus sends the driving signal, it continues to detect the uplink signal, and then the driving signal will be sent until the next time the uplink signal is detected.

The stylus and the touch screen shown in FIG. 1 supports the signal driving mode that periodically drives, and the stylus and the touch screen shown in FIG. 2 supports the signal driving mode that the uplink signal triggers the driving.

Since different touch screens support different signal driving modes, for a stylus, it can only be applied to one type of the touch screen, and cannot achieve the purpose of writing on multiple touch screens with one stylus, that is, “one pen for multiple devices” cannot be achieve, which greatly limits the range of use of the stylus.

Therefore, embodiments of the present application provide a signal driving solution, such that the stylus can write on the touch screen that supports different signal driving modes.

The “driving” in the embodiments of the present application is “sending the driving signal”, and the driving signal may also be referred to as a drive signal. The uplink signal may also be referred as a synchronization signal.

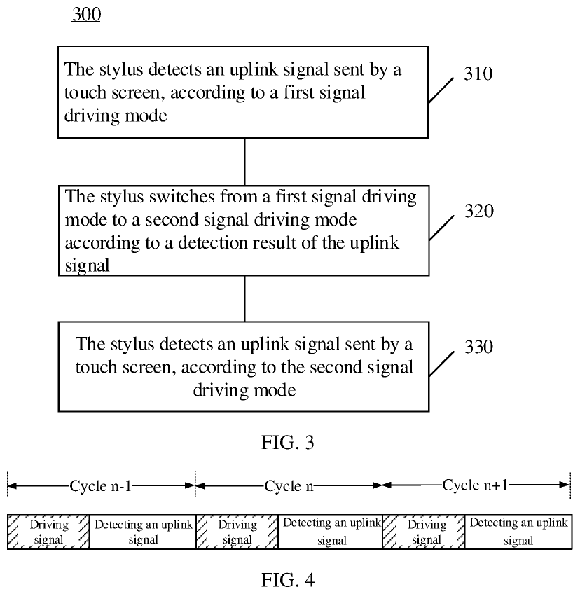

FIG. 3 is a schematic flowchart of a signal driving method according to an embodiment of the present application. This method can be executed by a stylus, and the stylus supports a plurality of signal driving methods. As shown in FIG. 3, the method includes some or all of the following steps.

In 310, the stylus detects the uplink signal sent by the touch screen, according to the first signal driving mode.

In 320, the stylus switches from the first signal driving mode to the second signal driving mode, according to the detection result of the uplink signal.

In 330, the stylus sends the driving signal to the touch screen, according to the second signal driving mode.

Here, the driving signal in the embodiment of the present application is configured for the touch screen to determine the location information and/or the pressure information of the stylus on the touch screen.

In the embodiment, the stylus detects the uplink signal and switches between a plurality of signal driving modes according to the detection result of the uplink signal, such that the stylus can write on the touch screen that supports different signal driving modes.

The switching of the stylus from the first signal driving mode to the second signal driving mode is based on the detection result of the uplink signal. Therefore, the stylus can realize automatic switching between different signal driving modes without other auxiliary devices.

The following describes in detail how the stylus switches between the first signal driving mode and the second signal driving mode with reference to FIGS. 4 to 9. The first signal driving mode and the second signal driving mode can have the following situations.

Situation 1

The first signal driving mode is a mode that periodically sends a driving signal, where each cycle includes a first period and a second period, the first period is configured to send the driving signal, and the second period is configured to detect an uplink signal.

For example, as shown in FIG. 4, the stylus periodically sends a driving signal to the touch screen. In cycle n−1, cycle n, or cycle n+1, the stylus sends the driving signal to the touch screen during the time period shown by the shadow, and is free for the rest of the cycle. The difference from FIG. 1 is that although the stylus periodically sends the driving signal, in FIG. 4, the stylus needs to detect the uplink signal during the free cycle when the driving signal is not sent.

The second signal driving mode is a mode that sends a driving signal based on an uplink signal, where the stylus sends the driving signal in response to a correctly detected uplink signal.

Reference is made to the description of FIG. 2 for the second signal driving mode, and the stylus sends the driving signal to the touch screen after the uplink signal is correctly detected. If the stylus correctly detects the uplink signal, the stylus sends the driving signal to the touch screen after the time delay T1, and the stylus sending the driving signal can last for a duration of T2.

That is, in situation 1, the stylus can switch from the signal driving mode that periodically drives to the signal driving mode triggered by the uplink signal.

In this time, optionally, in 320, if the number of times that the stylus correctly detects an uplink signal is greater than N, the stylus switches from the first signal driving mode to the second signal driving modem, where N is a positive integer.

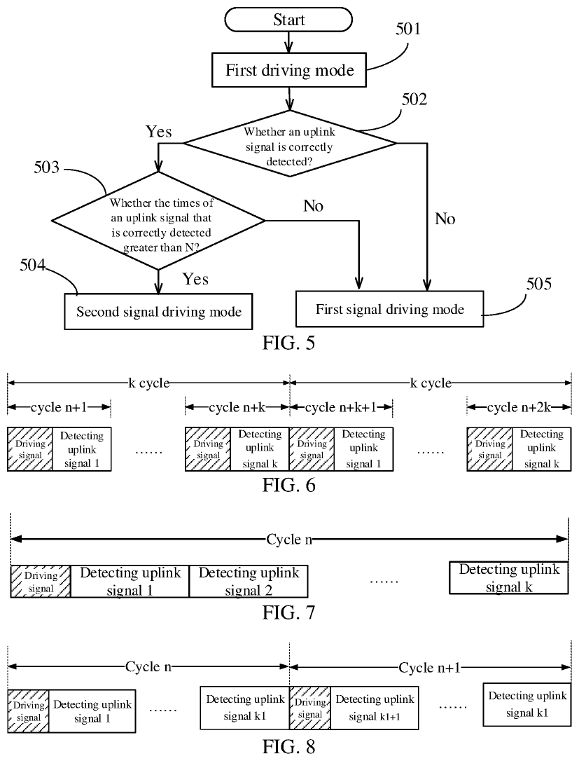

For example, as shown in FIG. 5, the stylus determines whether to switch from the first signal driving mode to the second signal driving mode according to whether the uplink signal is detected.

In 501, the stylus uses the first signal driving mode.

At this time, based on the method shown in FIG. 4, the stylus periodically sends the driving signal to the stylus and detects the uplink signal.

In 502, the stylus determines whether the uplink signal is correctly detected.

If the stylus does not correctly detect the uplink signal, it means that the touch screen may not support the transmission of the uplink signal. Therefore, the stylus still uses the first signal driving mode to send the driving signal, that is, execute 505.

If the stylus correctly detects the uplink signal, it is indicated that the touch screen supports the transmission of the uplink signal, the stylus executes 503.

In 503, the stylus determines whether the number of times that the uplink signal is correctly detected is greater than N.

If the number of times that the stylus correctly detects the uplink signal is less than or equal to N, the stylus executes 505.

If the number of times that the stylus correctly detects the uplink signal is greater than N, then execute 504.

In 504, the stylus switches from the first signal driving mode to the second signal driving mode.

At this time, the stylus uses the second signal driving mode to send the driving signal.

In 505, the stylus uses the first signal driving mode to send the driving signal.

Here, the setting of N can ensure the reliability of signal driving mode switching.

It should be understood that, in 503, the number of times that the uplink signal is correctly detected may be the number of times that the uplink signal is consecutively and correctly detected, or the number of times that the uplink signal is correctly detected in K detections, and K is a preset value, which is not limited in the embodiments of the present application. In addition, the stylus may also determine whether to switch from the first signal driving mode to the second signal driving mode according to whether the proportion of the uplink signal correctly detected in a plurality of consecutive detections is greater than a threshold.

For different touch screens supporting the second signal driving mode, since the stylus protocol used may be different, the uplink signals sent by different touch screens may also be different, for example, the coding information of the uplink signals sent by different touch screens is different. Therefore, when the stylus is used on a touch screen, the uplink signal that the stylus can be correctly detected should be the uplink signal sent by the touch screen. As for the uplink signal sent by other touch screens, the stylus may not be able to detect it correctly.

Different signal driving modes are agreed by different stylus protocols, and the uplink signals agreed in different protocols are different. Therefore, the correct signal transmission can be carried out between the stylus and the touch screen using the same protocol. The stylus in the embodiments of the application supports a plurality of protocols. However, when the stylus is used on a touch screen, it does not know the protocol supported by the touch screen, that is, it does not know whether the touch screen supports sending uplink signals and sending which kind of uplink signal.

Therefore, in 310, the stylus needs to detect a plurality of uplink signals.

Optionally, the active may detect a plurality kinds of uplink signals respectively in a plurality of consecutive cycles; or the stylus may detect a plurality kinds of uplink signals in each cycle. Here, the coding information of the plurality kinds of uplink signals is different.

Or, optionally, the stylus detects a plurality sets of the uplink signals in a plurality of consecutive cycles. That is, the stylus detects a group of uplink signals in each cycle. Here, each set of the uplink signals includes a plurality kinds of uplink signals, and the coding information of the plurality kinds of uplink signals is different.

The plurality kinds of uplink signals are respectively uplink signals in plurality of protocols, or in other words, the plurality kinds of uplink signals are uplink signals corresponding to a plurality of signal driving modes.

Assuming that the stylus supports k signal driving modes, the k uplink signals corresponding to the k signal driving modes are uplink signal 1 to uplink signal k, respectively.

For example, as shown in FIG. 6, the stylus detects the uplink signal in the cycle n+1 to the cycle n+2k in sequence, according to the first signal driving mode, where one type of uplink signal is detected in each cycle. As shown in FIG. 6, the stylus detects the uplink signal 1 to the uplink signal k in the cycle n+1 to the cycle n+k, and detects the uplink signal 1 to the uplink signal k in the cycle n+k+1 to the cycle n+2k.

For another example, as shown in FIG. 7, the stylus detects the uplink signal 1, the uplink signal 2, . . . , the uplink signal k in the cycle n according to the first signal driving mode. The stylus detects k kinds of uplink signals in one cycle.

For another example, as shown in FIG. 8, the stylus detects the uplink signal 1 to the uplink signal k1 in the cycle n, according to the first signal driving mode, and detects the uplink signal k1+1 to the uplink signal k in the cycle n+1, where k1<k.

The coding information of different uplink signals is different. The coding information for example, includes at least one information of: a length of coded pulse, pulse sequence, code system, bit of coded digits, and like. The following will be explained in detail.

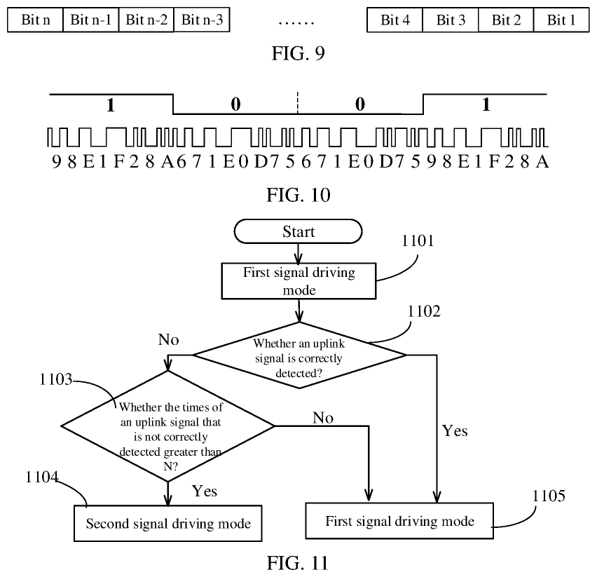

Usually, the uplink signal is composed of a plurality of digits, and each digit is represented by a certain length of coded pulse. For example, as shown in FIG. 9, the uplink signal can be composed of N bits, namely bit 1 to bit N, where each bit can represent a number. For the binary system, each bit can represent two numbers, 1 or 0. For the ternary system, each bit can represent three numbers. In the following, the binary system is used as an example for description.

In different protocols, the meaning of each bit in the N bits can be different, and the touch screen can transmit commands to the stylus through these N bits. For example, N bits can represent information such as the number of the pen, coordinate signal driving length of the pen, data coding length of the pen, coding frequency of the pen, etc. After the stylus detects the N-bit uplink signal, according to the information carried in the uplink signal, the touch screen sends a driving signal.

The number in each bit in FIG. 9 can be represented by, for example, the code pulse shown in FIG. 10, and FIG. 10 is merely an example. FIG. 10 shows the value of 4 bits, which are 1001 respectively, where the pulse sequence 0x98E1F28A is used to represent the number “1”, and the pulse sequence 0x671E0D75 is used to represent the number “0”. The length of each pulse sequence in FIG. 10 may be, for example, 32 us, so the time occupied by one bit is 32 us. The stylus decodes the pulse sequence, and can identify the information carried in the pulse sequence.

Different protocols agrees on different uplink signals, and the coding information of these different uplink signals is different, for example, one or more of the information such as the length of the coded pulse, the pulse sequence, the coding system, and the number of bits of the coded digits are different.

When the stylus detects each type of uplink signal, it needs to use the coding information of the uplink signal to correctly detect the uplink signal. For example, when the stylus is used on the touch screen using protocol 1, it needs to detect the uplink signal according to the coding information agreed in protocol 1 to correctly detect the uplink signal when the stylus is used on the touch screen using protocol 1. If the uplink signal is detected according to the coding information agreed in protocol 2, the uplink signal sent by the touch screen cannot be detected correctly.

The “correctly detected” mentioned in the embodiments of the present application means that the stylus correctly demodulates the uplink signal and obtains the information carried therein; “not correctly detected” means that the stylus does not detect the uplink signal or detects that there is an uplink signal but failed to correctly demodulate the uplink signal, in other words, it means that the stylus does not detect the uplink signal or detects the wrong uplink signal.

When the stylus detects the uplink signal based on the methods of FIGS. 6 to 8, if a certain uplink signal is correctly detected, it may no longer detect other uplink signals, but only detects the uplink signal in the subsequent cycle. For example, if the stylus detects the uplink signal 2 correctly, then the stylus only needs to detect the uplink signal 2 based on the coding information corresponding to the uplink signal 2, and no longer using the coding information of other uplink signals to detect other uplink signals.

Situation 2

The first signal driving mode is a mode that sends a driving signal based on an uplink signal, where a stylus sends the driving signal in response to a correctly detected uplink signal.

Reference is made to the description of FIG. 2 for the first signal driving mode, and the stylus sends the driving signal to the touch screen after the uplink signal is correctly detected. If the stylus correctly detects the uplink signal, the stylus sends the driving signal to the touch screen after the time delay T1, and the stylus sends the driving signal for a duration of T2.

The second signal driving mode is a mode that periodically sends a driving signal, where each cycle includes a first period and a second period, the first period is configured to send the driving signal, and the second period is configured to detect an uplink signal.

The second signal driving mode, for example, as shown in FIG. 4, the stylus periodically sends a driving signal to the touch screen. In cycle n−1, cycle n, or cycle n+1, the stylus sends the driving signal to the touch screen during the time period shown by the shadow, and is free for the rest of the cycle.

That is, in situation 2, the stylus can be switched from a signal driving mode that triggers the uplink signal to a signal driving mode that the periodically drives.

In this time, optionally, in 320, if the number of times that the stylus does not correctly detect an uplink signal is greater than M, the stylus switches from the first signal driving mode to the second signal driving mode, where M is a positive integer.

For example, as shown in FIG. 11, the stylus determines whether to switch from the first signal driving mode to the second signal driving mode according to whether the uplink signal is detected.

In 1101, the stylus uses the first signal driving mode.

At this time, the stylus sends the driving signal to the touch screen in response to the uplink signal based on the method shown in FIG. 2.

In 1102, the stylus determines whether the uplink signal is correctly detected.

If the stylus correctly detects the uplink signal, then execute 1105.

If the stylus does not correctly detect the uplink signal, it means that the touch screen may not support the transmission of the uplink signal, so the stylus executes 1103.

In 1103, the stylus determines whether the number of times that the uplink signal not correctly detected is greater than M.

If the number of times that the stylus does not correctly detect that the uplink signal is less than or equal to M, the stylus executes 1105.

If the number of times that the stylus does not correctly detect the uplink signal is greater than M, then execute 1104.

Here, the setting of M can ensure the reliability of signal driving mode switching.

In 1104, the stylus switches from the first signal driving mode to the second signal driving mode.

At this time, the stylus uses the second signal driving mode to periodically send the driving signal.

In 1105, the stylus uses the first signal driving mode to send the driving signal.

It should be understood that, in 1103, the number of times that the uplink signal is not correctly detected may be the number of times that the uplink signal is not consecutively and correctly detected, or the number of times that the uplink signal is not correctly detected in K detections, and K is a preset value, which is not limited in the embodiments of the present application. In addition, the stylus may also determine whether to switch from the first signal driving mode to the second signal driving mode according to whether the proportion of the uplink signal not correctly detected in a plurality of consecutive detections is greater than a threshold.

Situation 3

The first signal driving mode is a mode that sends a driving signal based on an uplink signal, where a stylus sends the driving signal in response to an uplink signal corresponding to the first signal driving mode.

The second signal driving mode is a mode that sends a driving signal based on an uplink signal, where a stylus sends the driving signal in response to an uplink signal corresponding to the second signal driving mode.

Here, the coding information of the uplink signal corresponding to the second signal driving mode is different from that of the uplink signal corresponding to the first signal driving mode.

In situation 3, both the first signal driving mode and the second signal driving mode are signal driving modes based on the signal driving mode that the uplink signal triggers the driving, but in the first signal driving mode and the second signal driving mode, the uplink signal sent by the touch screen is different, for example, the coding information is different. That is, the first signal driving mode and the second signal driving mode are signal driving modes in different protocols.

In this time, optionally, in 320, if the number of times that the stylus does not correctly detect an uplink signal corresponding to the first signal driving mode is greater than M, the stylus switches from the first signal driving mode to the second signal driving mode.

After the stylus switches to the second signal driving mode, it detects the uplink signal corresponding to the second signal driving mode. If the stylus detects the uplink signal corresponding to the second signal driving mode, it means that the stylus may move from the touch screen supporting the first signal driving mode to the touch screen supporting the second signal driving mode.

It should be understood that the above values of M and N are not limited in the embodiments of the present application. The settings of M and N can ensure the reliability of signal driving mode switching.

For example, in FIG. 11, when M=1, step 1103 can be omitted. That is, in 1102, if the stylus correctly detects the uplink signal, then execute 1105; if the stylus does not correctly detect the uplink signal, then execute 1104. However, considering that when the stylus is in use, the uplink signal may not be correctly detected due to signal interference or offset of the stylus, but at this time, the stylus does not move to other touch screens, the stylus and the touch screen still follow the first signal driving mode. Therefore, M>1 can be set to switch from the first signal driving mode to the second signal driving mode when the stylus fails to correctly detect the uplink signal for a plurality of times, thereby improving the reliability of the solution.

Similarly, in order to improve reliability, in FIG. 5, N>1 can be set. Here, when N=1, step 503 in FIG. 5 can be omitted. That is, in 502, if the stylus correctly detects the uplink signal, then execute 504; if the stylus does not correctly detect the uplink signal, then execute 505.

In the embodiments of the present application, the stylus can switch from the signal driving mode that periodically drives to the signal driving mode that the uplink signal triggers the driving, with reference to situation 1; the stylus can also switch from the signal driving mode that the uplink triggers the driving to the signal driving mode that periodically drives, with reference to situation 2; the stylus can also switch from one signal driving mode that the uplink triggers the driving to another signal driving mode that the uplink triggers the driving, but the uplink signals switched before and after the signal driving mode are different, with reference to situation 3. And, it can be understood that at least two of the foregoing situation 1, situation 2 and situation 3 can be combined.

For example, a default signal driving mode that the stylus is set to a signal driving mode 1, where the signal driving mode 1 is a mode that periodically drives. After the stylus is activated, it will periodically send driving signals and detect uplink signals. The stylus also supports a signal driving mode 2, and the signal driving mode 2 is the mode that the uplink signal triggers the driving. If the stylus correctly detects the uplink signal corresponding to the signal driving mode 2 and reaches N times, the stylus can switch from the signal driving mode 1 to the signal driving mode 2. The stylus continues to detect the uplink signal corresponding to the signal driving mode 2.

At this time, if the stylus only supports the signal driving mode 1 and the signal driving mode 2, then the stylus can switch from the signal driving mode 2 to the default signal driving method 1 when it does not correctly detect the uplink signal corresponding to the signal driving mode 2 and reaches M times.

Or, if the stylus also supports a signal driving mode 3, and the signal driving mode 3 is the mode that the uplink signal triggers the driving. Then, if the stylus does not correctly detect the uplink signal corresponding to the signal driving mode 2 and reaches M times, the stylus can detect the uplink signal corresponding to the signal driving mode 3. If the stylus correctly detects the uplink signal corresponding to the signal driving mode 3 and reaches N times, the stylus can switch from the signal driving mode 2 to the signal driving mode 3. If the stylus does not correctly detect the uplink signal corresponding to the signal driving mode 3 and reaches M times, the stylus can switch from the signal driving mode 3 to the default signal driving mode 1.

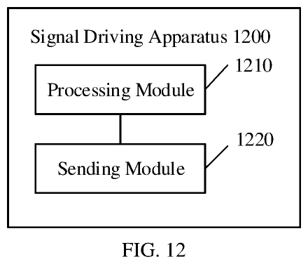

The embodiment of the present application further provides a signal driving apparatus. The signal driving apparatus is configured for a screen touch to send a driving signal to a touch screen, where the driving signal is configured for the touch screen to determine the location information and/or the pressure information of the stylus on the touch screen. As shown in FIG. 12, the signal driving apparatus includes:

a processing module 1210, configured to detect an uplink signal sent by a touch screen according to a first signal driving mode;

the processing module 1210 further configured to switch from a first signal driving mode to a second signal driving mode according to a detection result of the uplink signal; and

a sending module 1220, configured to send a driving signal to the touch screen according to the second signal driving mode, where the driving signal is configured for the touch screen to determine location information and/or pressure information of the stylus on the touch screen.

Therefore, the signal driving apparatus detects the uplink signal and switches between a plurality of signal driving modes according to the detection result of the uplink signal, such that the stylus can write on the touch screen that supports different signal driving modes.

Optionally, the first signal driving mode is a mode that periodically sends a driving signal, where each cycle includes a first period and a second period, the first period is configured to send the driving signal, and the second period is configured to detect an uplink signal; and the second signal driving mode is a mode that sends a driving signal based on an uplink signal, where the stylus sends the driving signal in response to a correctly detected uplink signal.

Optionally, the processing module 1210 is specifically configured to: detect a plurality kinds of uplink signals respectively in a plurality of consecutive cycles, where coding information of the plurality kinds of uplink signals is different.

Optionally, the processing module 1210 is specifically configured to: detect a plurality of kinds of uplink signals in each cycle, where coding information of the plurality kinds of uplink signals is different.

Optionally, the processing module 1210 is specifically configured to: detect a plurality sets of the uplink signals respectively in a plurality of consecutive cycles, where each set of the uplink signals includes a plurality kinds of uplink signals, and coding information of the plurality kinds of uplink signals is different.

Optionally, the processing module 1210 is specifically configured to: switch from the first mode to the second mode, if the number of times that an uplink signal is correctly detected is greater than N, where N is a positive integer.

Optionally, the first signal driving mode is a mode that sends a driving signal based on an uplink signal, where a stylus sends the driving signal in response to a correctly detected uplink signal; and the second signal driving mode is a mode that periodically sends a driving signal, where each cycle includes a first period and a second period, the first period is configured to send the driving signal, and the second period is configured to detect an uplink signal.

Optionally, the processing module 1210 is specifically configured to: switch from the first signal driving mode to the second signal driving mode, if the number of times that an uplink signal is not correctly detected is greater than M, where M is a positive integer.

Optionally, the first signal driving mode is a mode that sends a driving signal based on an uplink signal, where a stylus sends the driving signal in response to an uplink signal corresponding to the first signal driving mode; and the second signal driving mode is a mode that sends a driving signal based on an uplink signal, where a stylus sends the driving signal in response to an uplink signal corresponding to the second signal driving mode, coding information of the uplink signal corresponding to the first driving signal is different from that of the uplink signal corresponding to the second signal driving mode.

Optionally, the processing module 1210 is specifically configured to: switch from the first signal driving mode to the second signal driving mode, if the number of times that an uplink signal is not correctly detected corresponding to the first signal driving mode is greater than M, where M is a positive integer.

Optionally, the coding information includes at least one of: a length of coded pulse, pulse sequence, code system, and bit of coded digits.

It should be understood that the foregoing and other operations and/or functions of various modules of the signal driving apparatus 1200 of the embodiment of the present application are respectively configured to implement corresponding procedures of the signal driving method in FIG. 3. For brevity, details are not described herein again.

The embodiment of the present application further provides a stylus, including: the signal driving apparatus 1200 according to various embodiments of the present application.

The embodiment of the present application further provides a signal driving system, including: a touch screen; and the stylus according to various embodiments of the present application.

It should be noted that, under a premise of no conflict, various embodiments and/or technical features in the various embodiments described in the present application may be combined with each other arbitrarily, and the technical solutions obtained after the combination should also fall within the protection scope of the present application.

It should be understood that the specific examples in the embodiments of the present application are only to help those skilled in the art to better understand the embodiments of the present application, but not to limit the scope of the embodiments of the present application. Various modifications and variations which fall within the scope of the present application can be made by those skilled in the art based on the foregoing embodiments.

The foregoing descriptions are merely specific implementation manners of the present application. However, the protection scope of the present application is not limited thereto, and those skilled in the art who are familiar with the art could readily think of variations or substitutions within the technical scope disclosed by the present application, and these variations or substitutions shall fall within the protection scope of the present application. Therefore, the protection scope of the present application shall be subject to the protection scope of the claims.

What is claimed is:

1. A signal driving method, wherein the method comprises:
a stylus detecting an uplink signal sent by a touch screen, according to a first signal driving mode;
the stylus switching from the first signal driving mode to a second signal driving mode, according to a detection result of the uplink signal; and
the stylus sending a driving signal to the touch screen, according to the second signal driving mode, wherein the driving signal is configured for the touch screen to determine location information and/or pressure information of the stylus on the touch screen.

2. The signal driving method according to claim 1, wherein
the first signal driving mode is a mode that periodically sends a driving signal, wherein each cycle comprises a first period and a second period, the first period is configured to send the driving signal, and the second period is configured to detect an uplink signal; and
the second signal driving mode is a mode that sends a driving signal based on an uplink signal, wherein the stylus sends the driving signal in response to a correctly detected uplink signal.

3. The signal driving method according to claim 2, wherein the stylus detecting an uplink signal sent by a touch screen, according to a first signal driving mode, comprises:
the stylus detecting a plurality kinds of uplink signals respectively in a plurality of consecutive cycles, wherein coding information of the plurality kinds of uplink signals is different.

4. The signal driving method according to claim 2, wherein the stylus detecting an uplink signal sent by a touch screen, according to a first signal driving mode, comprises:
the stylus detecting a plurality of kinds of uplink signals in each cycle, wherein coding information of the plurality kinds of uplink signals is different.

5. The signal driving method according to claim 2, wherein the stylus detecting an uplink signal sent by a touch screen, according to a first signal driving mode, comprises:
the stylus detecting a plurality sets of the uplink signals respectively in a plurality of consecutive cycles, wherein each set of the uplink signals comprises a plurality kinds of uplink signals, and coding information of the plurality kinds of uplink signals is different.

6. The signal driving method according to claim 2, wherein the stylus switching from the first signal driving mode to a second signal driving mode, according to the detection result of the uplink signal, comprises:
if the number of times that the stylus correctly detects an uplink signal greater than N, the stylus switching from the first signal driving mode to the second signal driving mode, wherein N is a positive integer.

7. The signal driving method according to claim 1, wherein
the first signal driving mode is a mode that sends a driving signal based on an uplink signal, wherein a stylus sends the driving signal in response to a correctly detected uplink signal;
the second signal driving mode is a mode that periodically sends a driving signal, wherein each cycle comprises a first period and a second period, the first period is configured to send the driving signal, and the second period is configured to detect an uplink signal; and
wherein the stylus switching from a first signal driving mode to a second signal driving mode, according to a detection result of the uplink signal, comprises:
if the number of times that the stylus does not correctly detect an uplink signal is greater than M, the stylus switching from the first signal driving mode to the second signal driving mode, wherein M is a positive integer.

8. The signal driving method according to claim 1, wherein,
the first signal driving mode is a mode that sends a driving signal based on an uplink signal, wherein a stylus sends the driving signal in response to an uplink signal corresponding to the first signal driving mode; and
the second signal driving mode is a mode that sends a driving signal based on an uplink signal, wherein the stylus sends the driving signal in response to an uplink signal corresponding to the second signal driving mode, coding information of the uplink signal corresponding to the second signal driving mode is different from that of the uplink signal corresponding to the first signal driving mode.

9. The signal driving method according to claim 8, wherein the stylus switching from a first signal driving mode to a second signal driving mode, according to the detection result of the uplink signal, comprises:
if the number of times that the stylus does not correctly detect the uplink signal corresponding to the first signal driving mode is greater than M, the stylus switching from the first signal driving mode to the second signal driving mode, wherein M is a positive integer.

10. The signal driving method according to claim 3, wherein the coding information comprises at least one of:
a length of coded pulse, pulse sequence, code system, and bit of coded digits.

11. A signal driving apparatus, configured to send a driving signal to a touch screen, wherein the driving signal is configured for the touch screen to determine location information and/or pressure information of the stylus on the touch screen, the signal driving apparatus comprises:
a processing module, configured to detect an uplink signal sent by a touch screen according to a first signal driving mode;
the processing module further configured to switch from a first signal driving mode to a second signal driving mode according to a detection result of the uplink signal; and
a sending module, configured to send a driving signal to the touch screen, according to the second signal driving mode, wherein the driving signal is configured for the touch screen to determine the location information and/or the pressure information of the stylus on the touch screen.

12. The signal driving apparatus according to claim 11, wherein
the first signal driving mode is a mode that periodically sends a driving signal, wherein each cycle comprises a first period and a second period, the first period is configured to send the driving signal, and the second period is configured to detect an uplink signal; and
the second signal driving mode is a mode that sends a driving signal based on an uplink signal, wherein the stylus sends the driving signal in response to a correctly detected uplink signal.

13. The signal driving apparatus according to claim 12, wherein the processing module is specifically configured to:
detect a plurality kinds of uplink signals respectively in a plurality of consecutive cycles, wherein coding information of the plurality kinds of uplink signals is different.

14. The signal driving apparatus according to claim 12, wherein the processing module is specifically configured to:
detect a plurality of kinds of uplink signals in each cycle, wherein coding information of the plurality kinds of uplink signals is different.

15. The signal driving apparatus according to claim 12, wherein the processing module is specifically configured to:
detect a plurality sets of the uplink signals respectively in a plurality of consecutive cycles, wherein each set of the uplink signals comprises a plurality kinds of uplink signals, and coding information of the plurality kinds of uplink signals is different.

16. The signal driving apparatus according to claim 12, wherein the processing module is specifically configured to:
switch from the first mode to the second mode, if the number of times of an uplink signal correctly detected is greater than N, wherein N is a positive integer.

17. The signal driving apparatus according to claim 11, wherein
the first signal driving mode is a mode that sends a driving signal based on an uplink signal, wherein a stylus sends the driving signal in response to a correctly detected uplink signal;
the second signal driving mode is a mode that periodically sends a driving signal, wherein each cycle comprises a first period and a second period, the first period is configured to send the driving signal, and the second period is configured to detect an uplink signal; and
wherein the processing module is specifically configured to:
switch from the first signal driving mode to the second signal driving mode, if the number of times of an uplink signal that is not correctly detected is greater than M, wherein M is a positive integer.

18. The signal driving apparatus according to claim 11, wherein
the first signal driving mode is a mode that sends a driving signal based on an uplink signal, wherein a stylus sends the driving signal in response to an uplink signal corresponding to the first signal driving mode; and
the second signal driving mode is a mode that sends a driving signal based on an uplink signal, wherein a stylus sends the driving signal in response to an uplink signal corresponding to the second signal driving mode, coding information of the uplink signal corresponding to the first driving signal is different from that of the uplink signal corresponding to the second signal driving mode.

19. The signal driving apparatus according to claim 18, wherein the processing module is specifically configured to:
switch from the first signal driving mode to the second signal driving mode, if the number of times of an uplink signal that is not correctly detected corresponding to the first signal driving mode is greater than M, wherein M is a positive integer; and
wherein the coding information comprises at least one of:
a length of coded pulse, pulse sequence, code system, and bit of coded digits.

20. A stylus, comprising:
the signal driving apparatus according to claim 11.
